(19) United States
(12) Patent Application Publication
(10) Pub. No.: US 2013/0345318 A1
(43) Pub. Date: Dec. 26, 2013

(54) SILICONE POLYETHERS AND PREPARATION THEREOF FROM POLYETHERS BEARING METHYLIDENE GROUPS

(71) Applicant: Evonik Industries AG, Essen (DE)

(72) Inventors: Frank SCHUBERT, Neukirchen-Vluyn (DE); Michael Ferenz, Essen (DE); Wilfried Knott, Essen (DE)

(21) Appl. No.: 13/923,896

(22) Filed: Jun. 21, 2013

(30) Foreign Application Priority Data
Jun. 22, 2012 (DE) 10 2012 210 553.0

(51) Int. Cl. C08G 77/46; C08L 83/12

(52) U.S. Cl. CPC C08G 77/46; C08L 83/12
USPC 514/772; 556/434; 106/316; 516/9; 516/204; 516/124; 516/13; 556/401; 508/208

(57) ABSTRACT

Silicone polyethers and a process for preparation thereof wherein polyethers modified laterally with methylidene groups are reacted with hydrosiloxanes in a hydrosilylation reaction.

The present application claims priority from German Patent Application No. DE 10 2012 210 553.0 filed on Jun. 22, 2012, 2012, the disclosure of which is incorporated herein by reference in its entirety.

### FIELD OF INVENTION

The invention concerns silicone polyethers and a process for preparation thereof, wherein polyethers modified laterally with methylidene groups are reacted with hydrosiloxanes in a hydrosilylation reaction.

It is noted that citation or identification of any document in this application is not an admission that such document is available as prior art to the present invention.

The compounds of the invention represent a novel class of silicone polyethers in that the siloxane moiety attaches to the polyether via hydrolysis-stable SiC bonds. The novel compounds are termed silicone polyethers hereinbelow even though the structure may not always encompass the features of a polymeric ether and/or of a silicone in the usual sense. However, the structural agreement between polyether structural elements and silicones on the one hand and those of the novel compounds is clearly and distinctly apparent to a person skilled in the art.

The term “polyether” herein comprehends polyetherols and even polyether alcohols as well as polyethers, which may be used interchangeably. The “poly” fragment in these terms is not necessarily to be understood as meaning that a multiplicity of ether functionalities or alcohol functionalities in the molecule or polymer are concerned. It is rather merely used to indicate that there are at the very least repeat units of individual monomeric building blocks or alternatively compositions with a comparatively high molar mass and additionally also some polydispersity.

The word fragment “poly” encompasses in the context of this invention not just compounds having 3 or more repeat units of one or more monomers in the molecule, but especially also compositions of compounds which have a molecular weight distribution and a mean molecular weight of this distribution is at least 200 g/mol. This definition takes account of the fact that it is common practice in the pertinent art to call such compounds polymers even though they do not appear to satisfy a polymer definition as per OECD or REACH guidelines.

Silicone polyethers have a wide variety of uses, since their properties, especially their hydrophilic-hydrophobic balance, can be influenced, and adjusted to the desired value, by suitably selecting the siloxane block(s) on the one hand and by suitably constructing the polyether block(s) on the other.

There is a fundamental distinction in silicone polyethers between SiOC-linked systems on the one hand and SiC-linked systems on the other. While the hydrolysis-labile SiOC-linked systems can be prepared by reacting hydroxyl-functional polyethers with chlorosiloxanes or alkoxysiloxanes, the SiC-linked systems are notably obtained by the noble metal-catalysed hydrosilylation of usually monounsaturated polyethers with hydrosiloxanes. The noble metal-catalysed hydrosilylation of allyl polyethers has to compete with the allyl-propenyl rearrangement. This side reaction is undesired not only because it necessitates the use of excess polyether and hence entails some product dilution, but the hydrolytic degradation of the propenyl polyethers leads to formation of propionaldehyde which, among other effects, imparts an unpleasant odour to the product.

U.S. Pat. No. 3,957,843 and U.S. Pat. No. 4,059,605 disclose processes wherein the formation of propenyl polyethers in the hydrosilylation is sought to be avoided by using non-isomerizable, terminally unsaturated polyethers. Polyethers with the end group CH₂═CH—C(CH₃)₂—O are used for instance. U.S. Pat. No. 3,507,923 discloses methallyl-bearing polyethers which, under the conditions of hydrosilylation, have only little tendency to isomerize, if any. To get access to high molecular weight linear silicone-polyether copolymers, U.S. Pat. No. 4,150,048 discloses a hydrosilylation reaction whereby doubly SiH— functional siloxanes are reacted with polyethers which contain the structural element CH₂═C(alkyl)-CH₂—O twice and scarcely isomerize. The use of allyl polyethers, by comparison, has an increasing propensity due to the propenyl rearrangements to lead to chain terminations and less by way of long-chain copolymers. Silicone polyethers that are virtually free of unwanted propenyl-bearing polyethers are also disclosed in U.S. Pat. No. 4,160,775. The process described therein again rests on the use of certain alkylallyl-terminated polyethers having little propensity to isomerize.

U.S. Pat. No. 4,962,218 and U.S. Pat. No. 5,045,571 (EP0368195B1) describe inverted silicone polyethers, so called because unlike the conventional structures which feature a central silicone scaffold they have a polyunsaturated polyether which forms a central scaffold and which, in the second step, is modified by hydrosilylation with monofunctional hydrosiloxanes. The polyunsaturated polyether is prepared via alkoxylation of alkylene oxides mixed with olefinically unsaturated epoxides, for example allyl glycidyl ether. The olefinic epoxide can insert randomly or blockwise into the polyether chain which by alkaline catalysis can typically be built up to a chain length and hence molar mass of about 4000 g/mol. Although, EP 0 368 195 B1 claims a molecular weight range of 650 g/mol to 20 000 g/mol, only polyethers with molecular weights (determined via GPC) of 1020 g/mol to 1640 g/mol are explicitly disclosed. Depending on the reaction temperatures and catalyst concentrations, the allylic double bonds can isomerize to propenyl ethers even during the alkaline alkoxylation. The allylic double-bond fractions of the polyunsaturated polyether thus obtained can subsequently be reacted with distillatively purified SiH-functional silanes or siloxanes by noble metal-catalysed hydrosilylation. One advantage with the teaching of EP 0 368 195 is that the products are not diluted by excess propenyl polyether. The fact that the product purity of these inverted polyether siloxanes is enhanced is disclosed in EP 0 368 195 in terms of gel permeation chromatograms. EP 0 368 195 concedes, nonetheless, that only less than 90 mol % of the allyl groups are converted in the hydrosilylation of the polyunsaturated polyethers and that the remaining unsaturated groups are in the form of hydrolysis-labile propenyl functions. The problem of odour taint due to the hydrolytic release of propionaldehyde is thus unsolved. As a person skilled in the art would know the mere storage of a propenyl-containing polyether siloxane at room temperature leads to molar mass build-up and development of odour. To improve the stability in storage and avoid odour taint, the prior art discloses various deodorization techniques which, as an additional operation, increase cost while doing nothing to causally prevent the formation of propionaldehyde.

EP 0 506 086 A1 (U.S. Pat. No. 5,110,970) describes the preparation of inverted silicone-polyether copolymers in a two-step process. A polyunsaturated polyether is hydrosilylated with triethoxysilane in the first step. The alkoxysilyl-functional polyether obtained is then reacted with trimethylchlorosilane under hydrolytic conditions leading to the evolution of hydrogen chloride gas. Again only 85 mol % of the allyl groups are hydrolysed in EP 0 506 086 A1 (U.S. Pat. No. 5,110,970). Compared with a one-step hydrosilylation of ((CH₃)₃SiO)₃SiH, M3T for short, onto polyunsaturated polyethers, the two-step process via the alkoxysilyl-functional polyether as an intermediate does offer higher overall yields, but the hydrosilylating step incurs yield losses due to the allyl-propenyl rearrangement which are comparable to the teaching of EP 0 368 195. True, odour taint of the end product may be down as a result of the hydrolytic conditions of the second step and the distillative work-up, but the reaction concerned here is still not highly selective.

EP2289961 (US 2011/0046305) discloses perfectly propenyl-free inverted silicone polyethers, which are obtained by preferably acid-catalysed hydrolytic reaction of alkoxysilyl-functional polyethers with reactive alkoxysilanes. Using the selective double metal cyanide (DMC) catalysis in the alkoxylating step ensures that the alkoxysilyl-functional polyether used as precursor is free of unwanted propenyl units. The tendency of alkoxysilyl groups to self-condense and crosslink under the conditions of the acid-catalysed conversion with alkoxysilanes necessitates exact compliance with certain reaction conditions such as acid content, temperature, reaction time and degree of dilution and restricts access to the inverted silicone-polyether structures.

It is an object of the present invention to provide novel polyether-silicone compounds which do not have at least one disadvantage of the prior art.

For the purposes of this invention, the term “polyether-silicone compound” and the term “silicone moiety” comprehend compounds which have only one silicon atom. Silicone moieties of formula (1) are accordingly known as silanes in the prior art.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

We have found that the object of the present invention is achieved, surprisingly, by the polyether-silicone compounds of the present invention and as described in the claims.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

The present invention provides polyether-silicone compounds having only one methylene group between the polyether backbone and a silicon atom.

The present invention further provides a process for preparing polyether-silicone compounds containing at least one structural element of formula (1).

The present invention further provides for the use of the polyether-silicone compounds of the present invention, and also the products of the process according to the present invention.

The invention further provides compositions containing at least one component consisting of at least one polyether-silicone compound according to the present invention.

Preference is given to the polyether-silicone compounds of the present invention which contain at least one structural element of formula (1)

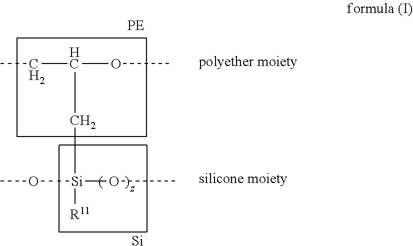

where the polyether moiety is described by formula (2)

A-[O—(R¹)ₙ—(R²)ₒ—(R³)ₚ—(R⁴)ₘ₁—(R⁵)ₘ₂—(R⁶)ₘ₃—(R⁷)ₘ₄—R⁸]ₐ₁ formula (2)
a1 is from 1 to 8, preferably from above 1 to 4 and more preferably from 2 to below 4,
A is either hydrogen or an organic radical of an organic starter compound having one or more carbon atoms,
(a1*n) is from 0 to 200, preferably from greater than 0 to 150 and more preferably from 1 to 100,
(a1*o) is from 1 to 1000, preferably from greater than 1 to 800, more preferably from 5 to 600, even more preferably from 8 to 500, yet even more preferably from 10 to 400 and still yet even more preferably from 30 to 100,
(a1*p) is from 0 to 150, preferably from above 0 to 200 and more preferably from 1 to 100,
(a1*m1) is below 50, preferably below 20, more preferably below 10, even more preferably less than 5 and yet even more preferably from 0 to less than 1,
(a1*m2) is below 50, preferably below 20, more preferably below 10, even more preferably less than 5 and yet even more preferably from 0 to less than 1,
(a1*m3) is below 30, preferably below 20, more preferably below 10, even more preferably less than 5 and yet even more preferably from 0 to less than 1,
(a1*m4) is from 1 to 50, preferably from greater than 1 to 20, more preferably from greater than 2 to 10 and even more preferably from above 3 to 5,
with the proviso that
   the sum total of the index products a1*(n+o+p+m1+m2+m3+m4) is not less than 3 and the units with the indices n, o, p, m1, m2, m3 and m4 can be freely arranged amongst each other in any desired order,
R¹=—CH₂CH₂O—
R²=—CH₂CH(CH₃)O— or —CH(CH₃)CH₂O—
R³=—CH₂CHRO— or —CHRCH₂O—
R⁴=—CH₂CH(CH₂OH)O— or —CH(CH₂OH)CH₂O—
R⁵=—CH₂CH(CH₂Cl)O— or —CH(CH₂Cl)CHO—
R⁶=—CH₂C(═CH₂)O— or —C(═CH₂)CH₂O—
R⁷=a structural element of formula (1), consisting of the moiety containing the atoms of the box bearing the sign PE
R⁸ independently in each occurrence is hydrogen or an alkyl group of 1-18 carbon atoms or a group R—C(═O)—,
R independently in each occurrence is either an alkyl group of 1-18 carbon atoms or an aromatic radical, especially a methyl group, an ethyl group or a phenyl radical,
   where the silicone moiety is described by formula (3) or formula (4),

MₐM^{H}_{b}M^{PE}_{c}D_{d}D^{H}ₑD^{PE}_{f}T_{g}Qₕ formula (3)

where
a is a number from 0 to 42, preferably from above 0 to 22, more preferably from 1 to 3 and even more preferably from greater than 1 to less than 2,
b is a number from 0 to 20, preferably from above 0 to 10, more preferably from 1 to 3 and even more preferably from greater than 1 to less than 2,
c is a number from 0 to 42, preferably from above 0 to 22, more preferably from 1 to 10 and even more preferably from greater than 1 to less than 3,
d is a number from 0 to 500, preferably from greater than 0 to 300, more preferably from 1 to 200 and even more preferably from greater than 1 to 100,
e is a number from 0 to 100, preferably from greater than 0 to 50, more preferably from 1 to 20, even more preferably from greater than 1 to 10, yet even more preferably from 2 to 5 and yet still even more preferably from above 2 to 3,
f is a number from 0 to 50, preferably from above 0 to 25 and more preferably from 1 to 10,
g is a number from 0 to 50, preferably from above 0 to 25, more preferably from 1 to 10, even more preferably from above 1 to 6 and yet even more preferably from 2 to not more than 3,
h is a number from 0 to 50, preferably from above 0 to 25, more preferably from 1 to 10, even more preferably from 1 to 6 and yet even more preferably from 2 to not more than 3,
z independently in each occurrence is equal to 0 or 1,
with the proviso that a+b+c is not less than 2
and with the proviso that c+f is at least 1 to 92, preferably from above 1 to 20 and especially at least 2 to 10,
and with the proviso that the units with the indices b, c, d, e, f, g and h can be freely arranged amongst each other in any desired order,

and where
M corresponds to the structural element [R¹¹₃SiO_{1/2}],
M^{H} corresponds to the structural element [R¹¹₂SiHO_{1/2}],
M^{PE} corresponds to a structural element of formula (1), consisting of the moiety containing the atoms of the box bearing the sign Si, wherein the valence which is free in formula (1) and which is shown by the broken-line bond (between the silicon atom and the oxygen atom outside the box) is saturated with an R¹¹ radical,
D corresponds to the structural element [R¹¹₂SiO_{2/2}],
D^{H} corresponds to the structural element [R¹¹SiHO_{2/2}],
D^{PE} corresponds to a structural element of formula (1), consisting of the moiety containing the atoms of the box bearing the sign Si, wherein the valence which is free in formula (1) and which is shown by the broken-line bond (leading from the oxygen atom with the index z to outside the box) is connected to a further structural element of formula (3),
T corresponds to the structural element [R¹¹SiO_{3/2}],
Q corresponds to the structural element [SiO_{4/2}],
R¹¹ in each occurrence independently represents identical or different alkyl radicals of 1 to 30 carbon atoms, or identical or different aryl radicals of 6-30 carbon atoms or —OH or —OR², preferably methyl, phenyl, —OH or —OR¹², and most preferably a methyl or phenyl group,
R¹² in each occurrence independently represents identical or different alkyl radicals of 1 to 30 carbon atoms, or identical or different aryl radicals of 6-30 carbon atoms, preferably an alkyl radical of 1 to 8 carbon atoms or a phenyl radical;

R¹¹₃Si— formula (4)
where R¹¹ is as defined above and the bond indicated in formula (4) represents the bond to the polyether moiety.

When the silicone moiety is described by formula (4), the valences in the silicone moiety which are free in formula (1) and which are represented by the broken-line bonds, where the index z is zero, are all saturated with an R¹¹ radical independently of each other.

It may be advantageous for the silicone moiety of the polyether-silicone compounds of the present invention not to contain oxygen atoms.

It may further be advantageous for the polyether-silicone compounds of the present invention not to contain any Si—H groups.

The polyether-silicone compounds of the present invention are further advantageous because they contain no detectable double-bond isomers. More particularly, the polyether-silicone compounds of the present invention are free of molecules and/or molecular fragments comprising or capable of forming propenyl groups.

The R⁷ radical of the polyether-silicone compounds according to the present invention is preferably non-terminal.

The compounds of formula (1) according to the present invention have a weight-average molar mass of 200 to 50 000 g/mol, preferably of 800 to 35 000 g/mol and more preferably of 1200 to 25 000 g/mol.

It is a further advantage of the polyether-silicone compounds of the present invention that they do not contain any so-called excess polyethers which, in conventionally obtained products, usually account for 20-40 wt % of the overall product. Excess polyethers refers to polyethers that are not bound to at least one silicon atom. The polyether-silicone compounds of the present invention are thus notable for the absence of free organic polyether fractions. Their chemical composition and hence their hydrophilic-hydrophobic balance are controllable between wide limits via the flexible choice of synthesis conditions. The length and arrangement of the hydrophobic siloxane body and the length and arrangement of the usually more hydrophilic polyether portion for instance are reproducibly variable within wide limits. One disadvantage of the prior art is overcome as a result, since in those cases where the polyether is hydrophilic, the excess polyether makes the end product too hydrophilic for surfactant applications.

A further advantage of the polyether-silicone compounds of the present invention is the provision of silicone polyethers according to the present invention in the form of storage-stable compounds which are free of troublesome by-products.

Storage stability for the purposes of the present invention is to be understood as meaning that the viscosity of the end product, when stored at room temperature in the absence of water, will not have increased significantly by more than 20% of the initial value one year later. This is particularly important for high molecular weight products having weight-average molar masses above 10 000 g/mol, since the initial viscosity of these products is already so high that all that is needed for gelation is a minimal, spectroscopically undetectable quantity of cross-linked chains.

Gelation as a cause of increased viscosity may be triggered, for example, by intermolecular hydrolysis and condensation reactions or by crosslinking side reactions in the presence of propenyl ether groups.

Viscosity can be measured in line with German standard specification DIN 53019 using a rotary viscometer, for example of the Haake RV12 brand, at 25° C.

A further advantage of polyether-silicone compounds according to the present invention is that no side reactions lead to the formation of propenyl ethers which on storage of the product are hydrolytically decomposed by the action of atmospheric humidity. And there is accordingly no evolved propionaldehyde to odour-taint the product. Hence the products are not just odourless in their as-prepared state, they also evolve no new undesired odoriphores during storage.

The polyether-silicone compounds of the present invention are further advantageously distinguished from the silicone polyethers disclosed in EP 0368195 A1 (U.S. Pat. No. 5,045,571 and U.S. Pat. No. 4,962,218) and EP 0506086 A1 (U.S. Pat. No. 5,110,970) in that as well as bound siloxanyl groups they may additionally contain individual or mixed methylidene groups as sites for subsequent polymer-analogous reactions.

The index numbers reproduced in the adduced formulae and the value ranges of the indices recited can be understood as means of the possible statistical distribution of structures actually present and/or mixtures thereof. This also holds for structural formulae which on the face of it have been reproduced exactly, as in the case of formula (2) for example.

The various monomer units of formulae (2), (3), (4), (5), (7) with the indicated indices in each case can form by statistical distribution. Statistical distributions may have a blockwise construction with any number of blocks and any sequence or be subject to a randomized distribution, they may also have an alternating construction or else form a gradient along the chain, in particular they can also form any hybrid thereof wherein groups of different distributions may follow each other.

The organic radical A is preferably a radical of the compound of formula (6)

A-(OH)ₐ₁ formula (6)

without the OH group, while a1 is as defined above.

Preferred structures of formula (6) are those derived from compounds of the group of the alcohols, polyetherols or phenols, preferably from allyl alcohol, butanol, octanol, dodecanol, stearyl alcohol, 2-ethylhexanol, cyclohexanol, benzyl alcohol, ethylene glycol, propylene glycol, diethylene glycol, triethylene glycol, polyethylene glycol, 1,2-propylene glycol, dipropylene glycol, polypropylene glycol, 1,4-butanediol, 1,6-hexanediol, trimethylolpropane, glycerol, pentaerythritol, sorbitol, mannitol, lactitol, xylitol, threitol, erythritol or hydroxyl-bearing compounds based on natural material. Particular preference is given to structures of formula (6) such as butanol, octanol, allyl alcohol or polyetherols, particular preference being given to butanol, octanol and allyl alcohol.

The radicals A preferably have a numerical molar mass of 15 to 4983 g/mol, more preferably 83 to 4983 g/mol, and even more preferably 113 to 4983 g/mol.

The polyetherols of formula (6) have a weight-average molar mass of up to 8000, preferably of up to 4000, more preferably of up to 2000 and even more preferably of up to 500 g/mol. The polyetherols of formula (6) are further notable for the polymerization of ethylene oxide and/or propylene oxide, especially the polymerization of propylene oxide. The polyetherols of formula (6) are preferably based on butanol as starter.

The radical A can be used to introduce further hydrosilylable carbon-carbon double bonds in order that the siloxane fraction of the silicone polymers according to the present invention may be increased. Thus, A can be a radical comprising one or more allyl or vinyl groups. Preference is given to radicals comprising hydrosilylable double bonds where the double bonds have no propensity to rearrange. Radicals comprising acrylate, methacrylate and/or methallyl groups are more preferable.

Particular preference is given to the polyether-silicone compounds according to the present invention which contain the structural element of formula (1) and which contain a polyether moiety of formula (2) where
a1 is 1
A is the organic radical of octanol or is a butanol-started polyether,
(a1*n) is 0,
(a1*o) is from 30 to 100,
(a1*p) is 0,
(a1*ml) is from 0 to below 1,
(a1*m2) is from 0 to below 1,
(a1*m3) is from 0 to below 1,
(a1*m4) is from 1 to 5,
with the proviso that the sum total of the index products a1*(n+o+p+m1+m2+m3+m4) is not less than 3,
the radicals R¹, R², R³, R⁴, R⁵, R⁶, R⁷, R⁸ and R are each as already defined above, and where the polyether-silicone compounds of formula (1) contain a silicone
   moiety of formula (3) or formula (4) where
      a is from 0 to below 2,
      b is from 0 to below 3,
      c is from 0 to below 3,
      d is from 0 to 100,
      e is from 0 to 2,
      f is from 0 to 10,
      g is from 0 to below 3,
      h is from 0 to below 3,
      z is 1,
      with the proviso that a+b+c is not less than 2
      and with the proviso that c+f is at least 1 to 10,
   the radicals M, M^{H}_{b}, M^{PE}_{c}, D_{d}, D^{H}ₑ, D^{PE}_{f}, T_{g}, Qₕ are each as already defined above,
   R¹¹ is methyl,
   R¹² represents identical or different alkyl radicals of 1 to 8 carbon atoms or phenyl radicals,
   where the definition for R¹¹ is likewise applicable in formula (4).

The substances of the present invention are obtainable in any desired manner, but the process described hereinbelow is preferable.

The process which the present invention provides for preparing polyether-silicone compounds comprises reacting a methylidene-substituted polyether of formula (5) with an SiH compound of formula (7) (hydrosiloxane) or of formula (8) (hydrosilane). This reaction is preferably embodied as a hydrosilylation.

Methylidene-substituted polyethers of formula (5) are

A-[O—(R¹)ₙ—(R²)ₒ—(R²)ₚ—(R⁴)ₘ₁—(R⁵)ₘ₂—(R⁶)ₘ₅—R⁸]ₐ₁ formula (5)

where
a1, (a1*n), (a1*o), (a1*p), (a1*m1), (a1*m2) and also A, R¹, R², R³, R⁴, R⁵, R⁶ and R⁵ are each as defined above, and where
(a1*m5) is from 1 to 80, preferably from greater than 1 to 50, more preferably from 2 to 30, and even more preferably from above 2 to less than 20, where
A is the organic radical of the compound of formula (6)

A-(OH)ₐ₁ formula (6)
without the OH group.

Methylidene-substituted polyethers of this type are obtainable by the process described in DE 10 2011 076019 via dehydrochlorination of chlorinated polyethers with metal hydroxides or alkoxides. These chlorine-containing polyethers are in turn available via prior double metal cyanide (DMC)-catalysed alkoxylation reaction of epichlorohydrin and possibly further epoxides on an OH-functional starter compound and are free of propenyl groups.

The method of preparing the methylidene-substituted polyethers is described at length in DE 10 2011 076019 as are the structural types which can be used in the context of this invention. The description and claims of DE 10 2011 076019 are hereby fully incorporated herein. The compounds thus obtained contain the modifiable methylidene functions as a statistical distribution of side groups.

The methylidene-substituted polyethers of formula (5) are generally colourless or yellowish orange products, which may be clear or opaque. They are obtainable in a specific and reproducible manner as regards structure build and molar mass. The sequence of monomer units can be varied within wide limits.

Where reference is made to natural products, for example sorbitol, in the context of this invention, this reference is in principle to be understood as meaning all isomers, although the particular naturally occurring isomers are preferred, i.e. the D-sorbitol (CAS RN 50-70-4) in the case referred to here. As to the definition of natural products, reference is made to the scope of the “Dictionary of Natural Products”, Chapman and Hall/CRC Press, Taylor and Francis Group, for example in the online version of 2011: http://dnp.chemnetbase.com/.

Wherever molecules or fragments of molecules have one or more stereocentres or can be differentiated into isomers on the basis of symmetries or on the basis of other effects e.g. restricted rotation, all possible isomers are co-encompassed by the present invention. Isomers will be known to a person skilled in the art, see particularly the definitions due to Prof. Kazmaier at Saarland University. More particularly, all possibilities arising from the stereochemical definitions of tacticity are encompassed, e.g. isotactic, syndiotactic, heterotactic, hemiisotactic, atactic. Polyethers and polyether fragments comprising an atactic sequence of substituents in part at least are preferred for the purposes of the invention.

The process of the present invention comprises reacting a methylidene-substituted polyether of formula (5) with an SiH compound of formula (7) (hydrosiloxane) or of formula (8) (hydrosilane). This reaction is preferably embodied as a hydrosilylation.

Hydrosiloxanes for the purposes of this invention are compounds of formula (7)

MₐM^{H}ᵢD_{d}D^{H}ₖT_{g}Qₕ formula (7)

where
a, d, g, h and the radicals M, M^{H}, D, D^{H}, T and Q are each as defined above,
i is a number from 0 to 62, preferably from 0 to 42 and especially from above 0 to 5,
k is a number from 0 to 150, preferably from 0 to 100, more preferably from 0 to 50 and even more preferably from above 0 to 30,
with the proviso that the sum total of the indices i+k is not less than 1 and preferably above 1.

Hydrosilanes for the purposes of this invention are compounds of formula (8)

R¹¹₃Si—H formula (8)

Any SiH compounds (hydrosiloxanes and/or hydrosilanes) can be used. These compounds are obtainable as described in the prior art.

The amounts in which the SiH compounds are used is in terms of the SiH groups selectively stoichiometric or in molar excess or deficiency relative to the methylidene groups of the methylidene group-substituted polyethers. The molar ratio of methylidene groups to SiH groups is preferably in the range of 0.8-1.5.

When the sum total of the indices i and k in formula (7) is 1, i.e. the siloxane component has only one SiH function, the inverted silicone polyethers obtained after the hydrosilylation are characterized in that the polyether chain described by formula (2) is laterally silicone-functionalized.

When the indices i and k sum to values greater than 1, the polyether chains in the silicone polyethers obtained will be linked with one another via silicone units. This bridging of polyether chains can go as far as leading to crosslinking, i.e. the building of gel-like or solid silicone polyethers.

When the index product (a1*m5) in formula (5) is greater than 1 and when the sum total of indices i and k in formula (7) is greater than 1, bridged and/or crosslinked molecules are formed.

Polyether-silicone compounds are obtainable in this way where the structural unit indexed m4 appears more than once in the molecule. The products can assume dendritic molecular structures emanating from one polyether moiety. But they can also represent silicones/siloxanes bridged by one polyether moiety.

It is similarly possible for silicone moieties wherein the sum total of the indices c and f is above 1 to be connected to two or more polyether moieties. The products can assume dendritic molecular structures emanating from one silicone moiety. But they can also represent polyethers bridged by one silicone moiety.

When in general the index product (a1*m4) in formula (2) or the index product (a1*m5) in formula (5) but also the sum total of the indices c and f in formula (3) or the sum total of the indices i and k in formula (7) assume values greater than 1, crosslinked structures comprising two or more silicone and polyether moieties can be formed.

The polyether-silicone compounds thus formed have a gel-like to solid consistency.

The methylidene-substituted polyethers contain double bonds which can be hydrosilylated without isomerizing in the course of hydrosilylation. The familiar allyl-propenyl rearrangement as a side reaction of hydrosilylation does not take place in the process of the present invention.

It can be advantageous to conduct the process of the present invention such that the methylidene groups of the polyether are reacted virtually quantitatively with the SiH groups of the siloxane and/or silane component.

Embodiments wherein the polyether-silicone compounds of the present invention no longer contain any free SiH groups are also advantageous.

It can be advantageous to conduct the process of the present invention such that methylidene-substituted polyether-silicone compounds form, characterized in that methylidene-substituted polyethers are only partially hydrosilylated with reactive SiH siloxanes.

Useful catalysts for the hydrosilylation reaction include in principle platinum compounds such as, for example, hexachloroplatinic acid, cis-platin, bis-(cyclooctene)platinum dichloride, carboplatin, platinum(0) divinyltetramethyldisiloxane complexes, so-called Karstedt catalysts, or else platinum(0) complexes with different olefins. Useful catalysts further include in principle rhodium, iridium and ruthenium compounds, for example tris(triphenyl-phosphine)rhodium(I) chloride or tris(triphenylphosphine)ruthenium(II) dichloride. Preferred catalysts for the purposes of the process according to the present invention are platinum(0) complexes, particular preference being given to Karstedt catalysts and so-called WK catalysts, which are obtained as described in EP 1520870 (U.S. Pat. No. 7,157,541).

The hydrosilylation reaction can be carried out as a one-pot process or as a metered-addition process, in one or more steps. To compatibilize the reactants or else to simplify the handling of viscid or solid reactants, the reaction can be carried out in solvents such as toluene or xylene for example. The reaction can similarly be carried out without a solvent, in the form of an emulsion polymerization. On a large industrial scale, the hydrosilylation can be run not only in a stirred tank as a classic batch operation but also as a continuous operation as described in EP 1013701 (U.S. Pat. No. 6,291,622) for example.

The hydrosilylation catalysts can be added to the reaction mixture or to one of the reactants, as a solid material or in dissolved form. The catalyst quantities used range from 1 to 500 ppm, preferably from 1 to 100 ppm and especially from 1 to 30 ppm of (noble) metal in the complex compounds based on the sum total of all starting materials.

The hydrosilylation can be carried out at temperatures ranging from 20 to 200° C., preferably at from 40 to 150° C. and more preferably at from 60 to 120° C. Conversion can be tracked via gas-volumetric determination of the siloxane-bound hydrogen. This involves decomposing a sample of the reaction mixture in an alkaline solution and using a gas burette to measure the hydrogen which evolves as a result.

The polyether-silicone compounds of the present invention, as obtained by the hydrosilylation, can be transparent or milkily cloudy, depending on the reactants used. Viscosities at room temperature range from 1 to 100 000 mPa*s, preferably from 1 to 50 000 mPa*s and more preferably from 1 to 20 000 mPa*s.

It can be advantageous for the hydrosilylation in the process of the present invention to be followed by a second reaction-type step, characterized in that the products of the hydrosilylation are converted in an equilibration reaction in the presence of cyclic and/or linear siloxanes (e.g. octamethylcyclotetrasiloxane (D4) and/or decamethylcyclopentasiloxane (DS5)), which optionally contain further functional groups, such as amino groups for example, into polyether-silicone compounds having longer silicone chains. Preference is given to using basic catalysts such as, for example, KOH, or tetramethylammonium hydroxide as per the prior art described in DE 60116592 for example. The products of this second reaction-type step may optionally contain on statistical average less than one structural element of formula (1), preferably at least 0.6, more preferably at least 0.8 and even more preferably at least 0.9 structural elements of formula (1).

The present invention likewise provides the polyether-silicone compounds of formula (1) which are obtained by the process according to the present invention. The structural element of formula (1) features in all the structures of the inventive silicone polyethers. As a result, they differ fundamentally from the structures described in the disclosed prior art. The siloxane units are chemically bonded to the polyether chain via a methylene bridge. The number of linking sites per polyether chain is defined by the index product (a1*m4) in formula (2).

The present invention further provides compositions containing at least one of the polyether-silicone compounds of formula (1) according to the present invention. Preference is given to compositions of the present invention which utilize further ingredients. Preferred ingredients are silicone surfactants, organic surfactants, solvents, such as, for example, alkanes, halogenated alkanes, substituted or unsubstituted aromatics, esters, ethers, glycols, oils of natural or synthetic origin or polyethers, amines, amides, acids, bases or their buffer systems for pH control, flame retardants, catalysts, antioxidants, additives to control the rheological properties, for example thickeners, wetting agents or flow control agents, dispersing additives, solid inorganic or solid organic fillers, particles, binders, solid or liquid dyes, stabilizers, UV absorbers, biocides and/or antistats.

The present invention further also provides for the use of the polyether-silicone compounds of the present invention, compositions containing at least one of the polyether-silicone compounds of the present invention, and also for the use of the products of the process of the present invention, as surfactants, emulsifiers, wetting and dispersing additives, paint flow control agents, lubricants, as textile auxiliaries, for surface treatment of fibres, yarns or fabrics, as defoamers, as thickeners and theology modifiers, as cosmetic additives and as foam stabilizers especially in polyurethane foam.

The present invention further provides for plastics articles, materials of construction, adhesives, sealants and coating materials comprising the silicone polyethers of the present invention.

The compounds of the present invention and the process of the present invention, compositions obtainable therewith and also their use are hereinbelow described by way of example without any intention to limit the invention to these exemplar) embodiments. Where ranges, general formulae or classes of compounds are referred to in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present description, their content shall fully form part of the disclosure content of the present invention. Percentages are by weight unless otherwise stated. Percentages in relation to compositions are based on the overall composition, unless otherwise stated. Average values referred to hereinbelow are number averages, unless otherwise stated. Molar masses are weight-average molar masses Mw, unless expressly stated otherwise. Viscosity values reported in the context of this invention are, unless otherwise stated, dynamic viscosities which can be determined using methods familiar to a person skilled in the art. Measured values reported hereinbelow were determined, unless otherwise stated, at a pressure of 1013 hPa and a temperature of 25° C.

The examples which follow describe the present invention by way of example without any intention to limit the invention, the scope of application of which is apparent from the entire description and the claims, to the embodiments referred to in the examples.

### OPERATIVE EXAMPLES

### General Methods and Materials

GPC measurements to determine the polydispersity and average molar masses were performed under the following conditions of measurement: column combination SDV 1000/10 000 Å (length 65 cm), temperature 30° C., THF as mobile phase, flow rate 1 ml/min, sample concentration 10 g/l, RI detector, evaluation against polypropylene glycol standard (76-6000 g/mol).

OH numbers were measured by the cold acetylation method based on analysis protocol C-V 17A (98) of the German Society for Fat Science (DGF).

Viscosities were measured on the basis of German standard specification DIN 53019 at 25° C. using a Haake RV12 rotary viscometer.

NMR spectroscopy was carried out using a spectrometer from Bruker: The ratio of the M, D and T units relative to each other was determined by ²⁹Si NMR spectroscopy at a frequency of 79.4 MHz; analyses for methylidene groups in the methylidene polyethers used were carried out using ¹³C NMR spectroscopy at 100 MHz; and the degree of conversion in the hydrosilylation reaction was determined using the ¹H NMR method at 400 MHz.

The following polyethers containing methylidene groups, which were prepared by the process disclosed in DE 10 2001 076019, were used:

Methylidene Polyether VP-1:

Almost colourless low-viscosity polypropylene glycol monobutyl ether having an average molar mass M_{w} of about 3300 g/mol and containing on average, according to ¹³C NMR analysis, 3.6 mol of methylidene groups per molecule [(a1*m5)=3.6 in formula (5)].

Methylidene Polyether VP-2:

Slightly yellow low-viscosity polypropylene glycol monobutyl ether having an average molar mass M_{w} of about 3400 g/mol and containing on average, according to ¹³C NMR analysis, 3.8 mol of methylidene groups per molecule [(a1*m5)=3.8 in formula (5)].

### Example 1

### Preparing the Polyether-Silicone Compounds of the Present Invention

### Synthesis Example S1

21.8 g of 1,1,1,3,5,5,5-heptamethyltrisiloxane and 70.0 g of methylidene polyether VP-1 were mixed with each other. The reactants were heated to 70° C. and admixed with 91.8 mg of a solution of the Karstedt catalyst in decamethylcyclopentasiloxane (w (Pt)=1.0%). The reaction mixture was stirred at 70° C. for 2.5 hours and then devolatilized for three hours at 130° C. and <1 mbar. A clear yellowish liquid was obtained. Free methylidene groups are undetectable in the ¹³C and ¹H NMR spectrum. According to ²⁹Si NMR analysis, the molar ratio of M:D^{PE} is 2:1.

### Synthesis Example S2

51.1 g of a siloxane having a molar mass distribution and comprising on average 6 Si units as per the general formula Me₃SiO[SiMe₂O]₃[SiHMeO]₁SiMe₃ and 80.0 g of methylidene polyether VP-2 were mixed with each other. The mixture of reactants was heated to 80° C. and admixed with 131 mg of a solution of the Karstedt catalyst in decamethylcyclopentasiloxane (w (Pt)=1.0%). The reaction mixture was stirred at 100° C. for 2.5 hours. At the end of this period, a gel was obtained. The constituents of the siloxane which contain more than one SiHMeO unit in the molecular chain lead to increased molar mass and partial crosslinking.

### Synthesis Example S3

25 g of the product of Example S1 were admixed with 5 g of decamethylcyclopentasiloxane and 0.03 g of tetramethylammonium hydroxide pentahydrate. The mixture was stirred at 70° C. for six hours. A clear liquid product was obtained. Free methylidene groups are undetectable in the ¹³C NMR spectrum. According to ²⁹Si NMR analysis, the molar ratio of M:D:D^{PE} is 2:3.2:0.9.

### Example 2

### Measurements of Surface Tension

Measurements by the pendant drop method were performed in neat samples at 25° C. using a Dataphysics OCA 20 instrument. The surface tension values arithmetically determined from the drop shape using the associated image-recognition software were as follows:

Methylidene polyether VP-2: 31.5 mN/m

Synthesis Example S1: 24.5 mN/m

Synthesis Example S3: 21.0 mN/m

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A polyether-silicone compound that has a link between a polyether backbone and a silicon atom which consists of a methylene group.

2. The polyether-silicone compound according to claim 1;
wherein the polyether-silicone compound contains a structural element of formula (1): 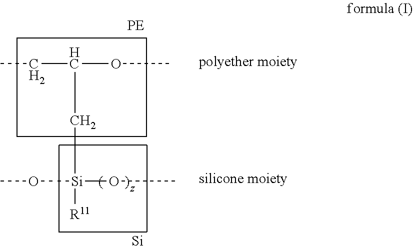
wherein the polyether moiety is described by formula (2):
A-[O—(R¹)ₙ—(R²)ₒ—(R³)ₚ—(R⁴)ₘ₁—(R⁵)ₘ₂—(R⁶)ₘ₃—(R⁷)ₘ₄—R⁸]ₐ₁ formula (2)
where:
a1 is from 1 to 8;
A is either:
hydrogen; or
an organic radical of an organic starter compound, and in this case is a radical having at least one carbon atom;
(a1*n) is from 0 to 200;
(a1*o) is from 1 to 1000;
(a1*p) is from 0 to 150;
(a1*ml) is below 50;
(a1*m2) is below 50;
(a1*m3) is below 30; and
(a1*m4) is from 1 to 50;
with the proviso that the sum total of the index products a1*(n+o+p+m1+m2+m3+m4) is not less than 3; and
where:
R¹=—CH₂CH₂O—;
R²═—CH₂CH(CH₃)O— or —CH(CH₃CH₂O—;
R³=—CH₂CHRO— or —CHRCH₂O—;
R⁴=—CH₂CH(CH₂OH)O— or —CH(CH₂OH)CH₂O—;
R⁵=—CH₂CH(CH₂Cl)O— or —CH(CH₂Cl)CHO—;
R⁶=—CH₂C(═CH₂)O— or —C(═CH₂)CH₂O—;
R⁷=a structural element of formula (1), consisting of the moiety containing the atoms of the box bearing the sign PE;
R⁸ independently in each occurrence is hydrogen or an alkyl group of 1-18 carbon atoms or a group R—C(═O)—;
R independently in each occurrence is either an alkyl group of 1-18 carbon atoms or an aromatic radical;
wherein the silicone moiety is described by formula (3) or formula (4);
wherein the formula (3) is:
MₐM^{H}_{b}M^{PE}_{c}D_{d}D^{H}ₑD^{PE}_{f}T_{g}Qₕ formula (3)
where:
a is a number from 0 to 42;
b is a number from 0 to 20;
c is a number from 0 to 42;
d is a number from 0 to 500;
e is a number from 0 to 100;
f is a number from 0 to 50;
g is a number from 0 to 50;
h is a number from 0 to 50; and
z is equal to 0 or 1;
with the proviso that a+b+c is not less than 2; and
with the proviso that c+f is at least 1 to 92; and
where:
M corresponds to the structural element [R¹¹₃SiO_{1/2}];
M^{H} corresponds to the structural element [R¹¹₂SiHO_{1/2}];
M^{PE} corresponds to a structural element of formula (1), consisting of the moiety containing the atoms of the box bearing the sign Si, wherein the valence which is free in formula (1) and which is shown by the broken-line bond (between the silicon atom and the oxygen atom outside the box) is saturated with an R¹¹ radical;
D corresponds to the structural element [R¹¹₂SiO_{2/2}];
D^{H} corresponds to the structural element [R¹¹SiHO_{2/2}];
D^{PE} corresponds to a structural element of formula (1), consisting of the moiety containing the atoms of the box bearing the sign Si, wherein the valence which is free in formula (1) and which is shown by the broken-line bond (leading from the oxygen atom with the index z to outside the box) is connected to a further structural element of formula (3);
T corresponds to the structural element [R¹¹SiO_{3/2}];
Q corresponds to the structural element [SiO_{4/3}];
R¹¹ in each occurrence independently represents:
identical or different alkyl radicals of 1 to 30 carbon atoms; or
identical or different aryl radicals of 6-30 carbon atoms; or —OH or —OR¹²; and
R¹² represents:
identical or different alkyl radicals of 1 to 30 carbon atoms; or
identical or different aryl radicals of 6-30 carbon atoms; and
wherein the formula (4) is:
R¹¹₃Si— formula (4)
where R¹¹ is as defined above and the bond represents the bond to the polyether moiety.

3. The polyether-silicone compound according to claim 2;
wherein the polyether-silicone compounds containing the structural element of formula (1) contain a polyether moiety of formula (2);
where:
a1 is 1;
A is the organic radical of butanol;
(a1*n) is 0;
(a1*o) is from 30 to 100;
(a1*p) is 0;
(a1*ml) is from 0 to below 1;
(a1*m2) is from 0 to below 1;
(a1*m3) is from 0 to below 1; and
(a1*m4) is from 1 to 5;
with the proviso that the sum total of the index products a1*(n+o+p+m1+m2+m3+m4) is not less than 3; and
where the radicals R¹, R², R³, R⁴, R⁵, R⁶, R⁷, R⁸ and R are each as already defined above; and
wherein the polyether-silicone compounds of formula (1) contain a silicone moiety of formula (3) or formula (4);
where:
a is from 0 to below 2;
b is from 0 to below 3;
c is from 0 to below 3;
d is from 0 to 100;
e is from 0 to 2;
f is from 0 to 10;
g is from 0 to below 3;
h is from 0 to below 3; and
z is 1;
with the proviso that a+b+c is not less than 2; and
with the proviso that c+f is at least 1 to 10; and
where:
the radicals M, M^{H}_{b}, M^{PE}_{c}, D_{d}, D^{H}ₑ, D^{PE}_{f}, T_{g}, Qₕ are each as already defined above;
R¹¹ is methyl; and
R¹² represents identical or different alkyl radicals of 1 to 8 carbon atoms or phenyl radicals.

4. A process for preparing the polyether-silicone compound according to claim 1, comprising:
reacting a methylidene-substituted polyether with an SiH compound.

5. The process according to claim 4,
wherein the methylidene-substituted polyether is a compound of formula (5):
A-[O—(R¹)ₙ—(R²)ₒ—(R^{3l )}ₚ—(R⁴)ₘ₁—(R⁵)ₘ₂—(R⁶)ₘ₅—R⁸]ₐ₁ formula (5);
where:
a1, (a1*n), (a1*o), (a1*p), (a1*ml), (a1*m2) are each as defined above,
(a1*m5) is from 1 to 80;
A is an organic radical of the compound of formula (6):
A-(OH)ₐ₁ formula (6);
without the OH group;
wherein the SiH compound is a compound of formula (7) or formula (8);
wherein the formula (7) is:
MₐM^{H}ᵢD_{d}D^{H}ₖT_{g}Qₕ formula (7);
where:
a, d, g, h and the radicals M, M^{H}, D, D^{H}, T and Q are each as defined above;
i is a number from 0 to 62, preferably from 0 to 42 and especially from 0 to 5; and
k is a number from 0 to 150, preferably from 0 to 100, more preferably from 0 to 50 and even more preferably from 0 to 30;
with the proviso that the sum total of the indices i+k is not less than 1; and
wherein the formula (8) is:
R¹¹₃Si—H formula (8);
where R¹¹ is as defined above.

6. A composition comprising:
the polyether-silicone compounds according to claim 2.

7. The composition according to claim 6, additionally comprising:
a further ingredient.

8. The composition according to claim 6;
wherein the further ingredient is selected from the group consisting of:
silicone surfactants, organic surfactants, solvents, acids, bases and their buffer systems for pH control, flame retardants, catalysts, antioxidants, additives to control the theological properties, dispersing additives, solid inorganic and solid organic fillers, particles, binders, solid and liquid dyes, stabilizers, UV absorbers, biocides, and antistats.

9. A method comprising:
utilizing the polyether-silicone compound according to claim 2, or a composition containing the polyether-silicone compound according to claim 2:
as a surfactant, an emulsifier, a wetting or dispersing additive, a paint flow control agent, or a lubricant;
as a textile auxiliary, for surface treatment of fibres, yarns, or fabrics; or
as a defoamer, as a thickener or theology modifier, as a cosmetic additive, as a foam stabilizer, or as a plastics article, a material of construction, an adhesive, a sealant, a binders, or a coating material.
